(19) United States
(12) Patent Application Publication
(10) Pub. No.: US 2009/0002742 A1
(43) Pub. Date: Jan. 1, 2009

(54) Image input/output apparatus and image input/output method

(75) Inventor: Kiyoshi Kasatani, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/213,049

(22) Filed: Jun. 13, 2008

(30) Foreign Application Priority Data
Jun. 27, 2007 (JP) 2007-169789

(51) Int. Cl. G06F 3/12

(52) U.S. Cl. 358/1.13; 382/190

(57) ABSTRACT

A disclosed image input/output apparatus includes an image information acquiring unit configured to acquire image information; an identification information recognition unit configured to recognize identification information included in the image information acquired by the image information acquiring unit; and an output control unit configured to identify and output the image information acquired by the image information acquiring unit based on the identification information recognized by the identification information recognition unit.

### BACKGROUND OF THE INVENTION

1. Field of the Invention

The present invention relates to an image input/output apparatus and an image input/output method.

2. Description of the Related Art

In recent years and continuing, multifunctional digital copiers having multiple functions such as those of a printer, scanner, and a facsimile machine are pervasive. In order effectively use a function of such a digital copier, the user is required to set numerous setting items such as image forming conditions. However, there are limits in the size of the liquid crystal display device and the number of hard keys provided as an input unit for inputting settings in the digital copier. Thus, the liquid crystal display device tends to have a large number of layers which are used for switching from one display page of setting menus to another. This degrades the user-friendliness.

To overcome such a problem, for example, patent document 1 discloses a technology for recording image forming conditions, which are in an optically readable format such as a barcode, reading and recognizing the barcode with a scanner of a digital copier, and automatically setting the image forming conditions.

In recent years and continuing, digital multifunction peripherals are positioned as terminals in a network. Accordingly, handwritten documents and paper materials can be converted into electronic files to be shared and utilized in the network. Furthermore, input images can be delivered to predetermined personal computers from the digital multifunction peripheral.

Patent Document 1: Japanese Laid-Open Patent Application No. 2007-221747

However, in a conventional digital multifunction peripheral, the following problem arises. When an electronic file, which is obtained by scanning a handwritten document or paper material with a scanner, is delivered to or saved in a predetermined personal computer, the user is required to input a data name in order to deliver or save the file in a data name desired by the user.

Thus, when numerous handwritten documents or paper materials are to be delivered or saved, the user is required to set numerous data names, which degrades the usability for the user. That is, when outputting (or accumulating) image information of each handwritten document or paper material, the user is required to set identification information (output name) of the image information, which degrades the usability for the user.

### SUMMARY OF THE INVENTION

The present invention provides an image input/output apparatus and an image input/output method in which one or more of the above-described disadvantages are eliminated.

A preferred embodiment of the present invention provides an image input/output apparatus and an image input/output method with which identification information of image information can be efficiently set when outputting the image information.

An embodiment of the present invention provides an image input/output apparatus including an image information acquiring unit configured to acquire image information; an identification information recognition unit configured to recognize identification information included in the image information acquired by the image information acquiring unit; and an output control unit configured to identify and output the image information acquired by the image information acquiring unit based on the identification information recognized by the identification information recognition unit.

An embodiment of the present invention provides an image input/output method performed by an image input/output apparatus for inputting/outputting image information, the image input/output method including an image information acquiring step of acquiring image information; an identification information recognition step of recognizing identification information included in the image information acquired at the image information acquiring step; and an output control step of identifying and outputting the image information acquired at the image information acquiring step based on the identification information recognized at the identification information recognition step.

According to one embodiment of the present invention, an image input/output apparatus and an image input/output method are provided, with which identification information of image information can be efficiently set when outputting the image information.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a digital copier according to a first embodiment of the present invention;

FIG. 2 is a functional block diagram of the digital copier according to the first embodiment of the present invention;

FIG. 3 is a flowchart of an operation performed by the digital copier according to the first embodiment of the present invention;

FIG. 4 illustrates an example of the acquired image information;

FIGS. 5A through 5C are for describing a process of outputting or storing the image information according to the identification information;

FIG. 6 is a functional block diagram of a digital copier according to a second embodiment of the present invention;

FIG. 7 illustrates an example of setting contents set in the job execution condition setting unit;

FIG. 8 illustrates an example of a displayed page prompting a user to set a keyword;

FIG. 9 is a flowchart of an operation of the digital copier according to the second embodiment of the present invention;

FIG. 10 illustrates an operation of the digital copier in a case where the file division unit number is one; and

FIG. 11 illustrates an operation of the digital copier in a case where the file division unit number is two or more.

### DETAILED DESCRIPTION OF THE PREFERRED EMBODIMENTS

A description is given, with reference to the accompanying drawings, of an embodiment of the present invention.

### First Embodiment

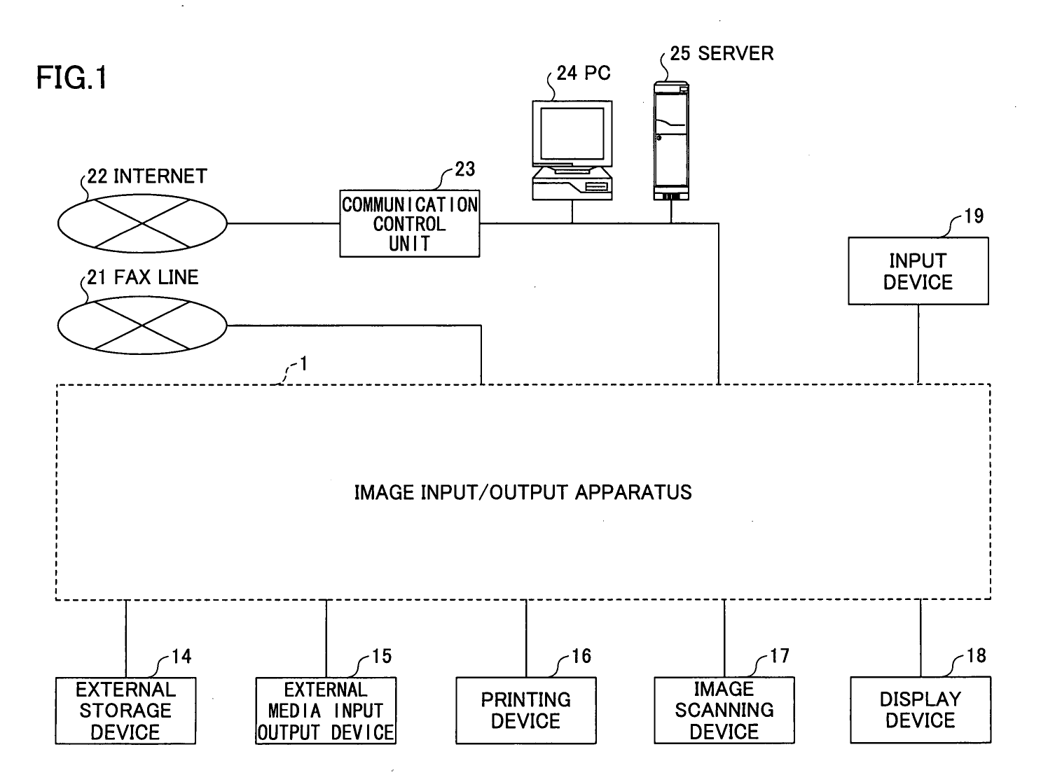

A first embodiment of the present invention is described with reference to FIGS. 1 through 5.

(Configuration of Device)

FIG. 1 is a block diagram of a digital copier according to a first embodiment of the present invention. The digital copier is taken as an example of an image input/output apparatus in the first embodiment.

As shown in FIG. 1, a digital copier (image input/output apparatus) 1 is connected, via a bus, to an external storage device 14, an external media input output device 15, a printing device 16, an image scanning device 17, a display device 18, and an input device 19.

Furthermore, the digital copier 1 transmits/receives facsimile data to/from another facsimile device via a fax line 21. Moreover, the digital copier a is connected to an external device via the Internet 22 and a communication control unit 23 such as a modem and a router. Furthermore, the digital copier 1 is connected to a personal computer (hereinafter, “PC”) 24 and a server computer (hereinafter, “server”) 25 in a wired or wireless manner and transmits/receives information.

The digital copier 1 includes a CPU (Central Processing Unit) for controlling the above-described devices connected to the digital copier 1, a memory unit including a ROM (Read Only Memory) and a RAM (Random Access Memory), a Fax control unit, a LAN control unit, an input/output device control unit, a storage device control unit, an image processing control unit, and an input control unit, which are not shown. Furthermore, the digital copier 1 includes a storage device including a built-in hard disk drive (hereinafter, “HDD”) connected to the storage device control unit, a print control unit connected to the image processing control unit, an image scanning control unit, and a display control unit.

The external storage device 14 is a storage device such as an external HDD (Hard Disk Drive). The external media input output device 15 is an input/output device used for inputting/outputting information with respect to a medium such as a multimedia card (registered trademark), smart media (registered trademark), a memory stick (registered trademark), an SD memory card (registered trademark), a CD-ROM, a floppy disk (registered trademark), and a USB memory (registered trademark).

The printing device 16 is an output device such as a monochrome printer, a color printer, a double-side printer, a laser printer, and an inkjet printer. The image scanning device 17 is for scanning an original image by an optical process to obtain electronic data. The display device 18 is an output device including such as a touch panel, a CRT, and a liquid crystal display.

The input device 19 is for inputting information with a touch panel and key buttons. The input device 19 may include a microphone for inputting a voice signal.

As described above, the digital copier 1 according to the first embodiment of the present invention controls various devices described above that are connected to (or included in) the digital copier 1.

Furthermore, the digital copier 1 performs control operations for identifying and outputting image information acquired with the image scanning device 17 according to identification information included in the image information. The identification information is for identifying an output file name (or a saving file name) in a computer. The digital copier 1 performs a process for outputting an image upon adding, as an output file name, the identification information included in the image information acquired by the image scanning device 17.

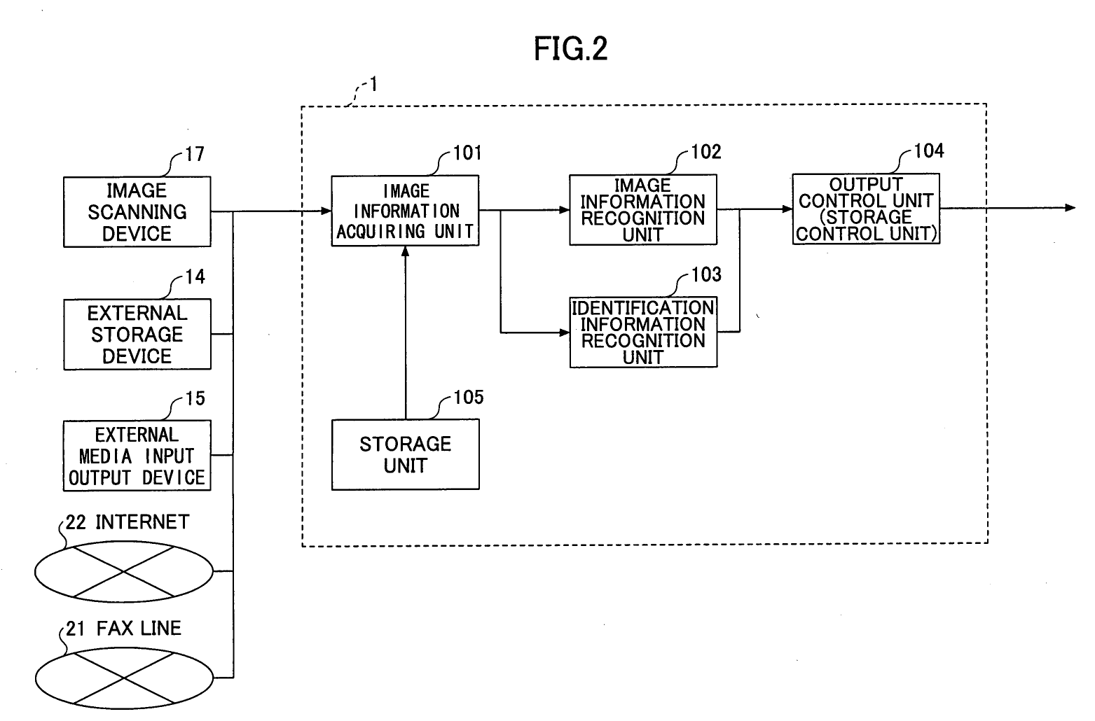

Accordingly, when image information is output (or stored), the identification information (for example, header information) of the image information can be efficiently set. Detailed configurations are described below with reference to FIG. 2.

(Configuration of Functions)

FIG. 2 is a functional block diagram of the digital copier 1 according to the first embodiment of the present invention. The arrows connecting the blocks shown in FIG. 2 express typical flows of signals, but do not limit the functions of the blocks.

As shown in FIG. 2, the digital copier 1 includes an image information acquiring unit 101, an image information recognition unit 102, an identification information recognition unit 103, an output control unit (storage control unit) 104, and a storage unit 105.

The image information acquiring unit 101 acquires image information. For example, the image information acquiring unit 101 acquires image information scanned by the image scanning device 17; image information stored in the external storage device 14, the external media input output device 15, or the storage unit 105; image information received from an external device connected via the Internet 22; and image information based on facsimile data received from another facsimile device via the fax line 21.

The image information recognition unit 102 recognizes image information acquired by the image information acquiring unit 101. The identification information recognition unit 103 recognizes identification information included in image information acquired by the image information acquiring unit 101. For example, the identification information recognition unit 103 recognizes identification information based on an optical scanning code such as a QR code (registered trademark) included in the image information. Identification information is for identifying, in a computer, an output file name (or a saving file name) pertaining to the output (or storing) operation performed by the output control unit (storage control unit) 104 described below.

The output control unit (storage control unit) 104 identifies and outputs (or stores) image information recognized by the image information recognition unit 102 according to identification information recognized by the identification information recognition unit 103. For example, the output control unit (storage control unit) 104 adds, to image information, header information which is identification information, and the printing device 16 forms an image on a recording medium. For example, the output control unit (storage control unit) 104 adds identification information to a file name or a subject name of an electronic file generated based on the image information, and performs an output operation. The output operation may be performed by sending, by facsimile transmission, the electronic file to another facsimile machine via the fax line 21, or by sending the electronic file to an external device connected via the Internet 22. Furthermore, the output control unit (storage control unit) 104 adds identification to a file name (including a document name or a category name) of an electronic file generated based on image information, and stores the electronic file in the storage unit 105.

According to the above functional configuration, the digital copier 1 performs a control operation for identifying and outputting (or storing) image information acquired by the image scanning device 17, according to identification information included in the image information.

(Example of Operation)

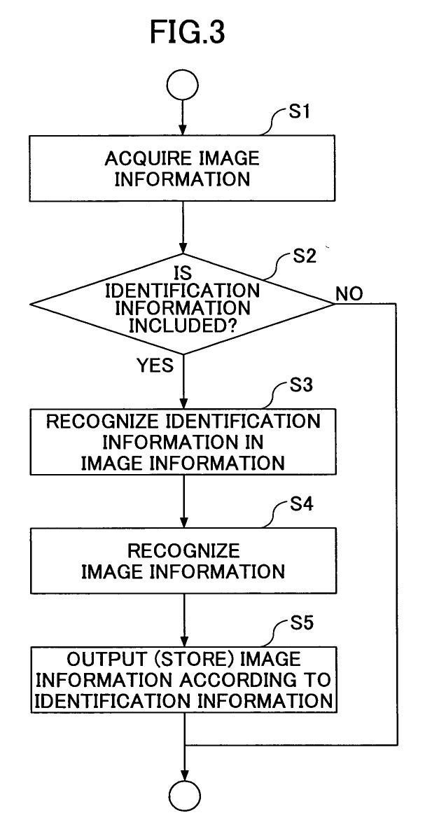

FIG. 3 is a flowchart of an operation performed by the digital copier 1 according to the first embodiment of the present invention. A description is given of a control operation performed by the digital copier 1, of outputting (or storing) image information acquired by the image scanning device 17, also with reference to the functional block diagram shown in FIG. 2.

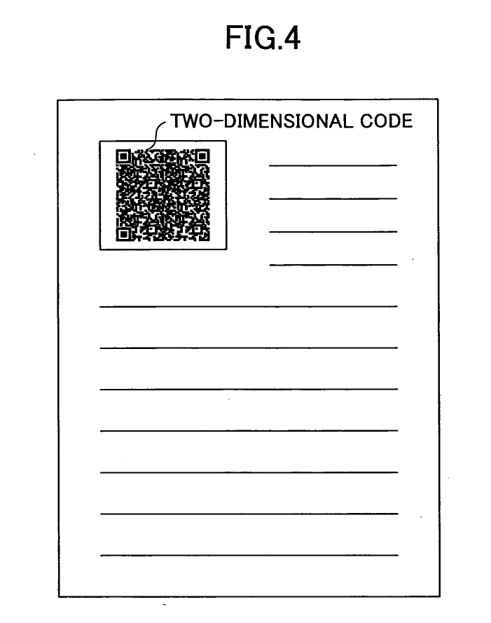

The image information acquiring unit 101 acquires image information (step S1). The image information acquiring unit 101 acquires image information scanned by the image scanning device 17; image information stored in the external storage device 14, the external media input output device 15, or the storage unit 105; image information received from an external device connected via the Internet 22; and image information based on facsimile data received from another facsimile device via the fax line 21. FIG. 4 illustrates an example of the acquired image information. The image information used in the first embodiment is image data having a two-dimensional code such as a QR code recorded at a predetermined position as shown in FIG. 4.

In step S2, the identification information recognition unit 103 determines whether the image information acquired at step S1 includes identification information (step S2). As described above, identification information is for identifying information in a computer, such as an output file name (or a saving file name). In this case, the identification information corresponds to a predetermined character string included in the QR code shown in FIG. 4.

When identification information is included (Yes in step S2), the process proceeds to step S3, and the identification information recognition unit 103 recognizes the identification information in the image information (step S3). In this case, the identification information recognition unit 103 recognizes a predetermined character string included in the QR code shown in FIG. 4. When identification information is not included (No in step S2), the process ends.

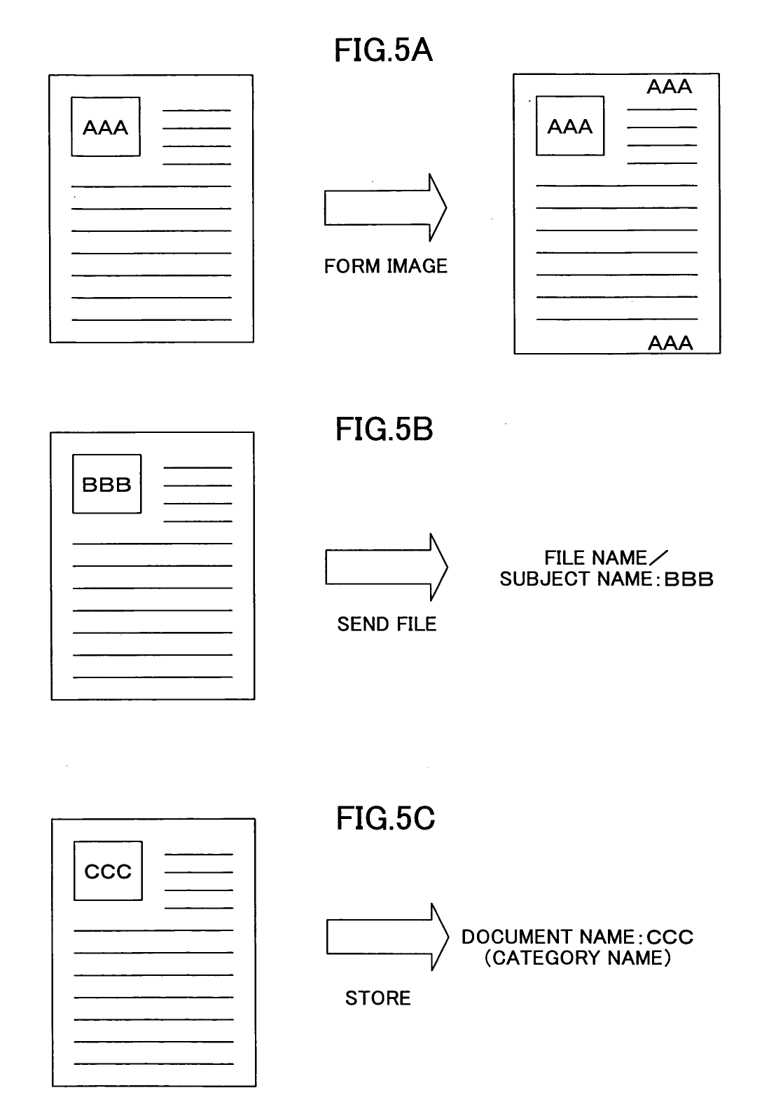

In step S4, the image information recognition unit 102 recognizes the image information acquired at step S1 (step S4). In this case, the image information recognition unit 102 recognizes the image information shown in FIG. 4. Next, in step S5, the output control unit 104 outputs (or stores) the image information recognized at step S4, according to the identification information recognized at step S3 (step S5). FIGS. 5A through 5C illustrate a process of outputting or storing the image information according to the identification information.

In step S5, for example, a predetermined character string recognized at step S3 is added to the image information as header information, and the printing device 16 forms an image on the recording medium (see FIG. 5A). In another example, identification information is added to a file name or a subject name of an electronic file generated based on the image information. Then, an output operation is performed by sending this electronic file by facsimile transmission to another facsimile device via the fax line 21, or to an external device connected via the Internet 22 (see FIG. 5B). In yet another example, identification information is added to the file name (including a document name and a category name) of an electronic file generated based on image information, and the electronic file is stored in the storage unit 105 (see FIG. 5C).

According to the above process, the digital copier 1 performs a control operation of identifying and outputting (or storing) image information according to identification information included in the image information, which image information is acquired by the image scanning device 17. Thus, when outputting (or storing) image information, the identification information of the image information can be effectively set by recording an output file name (or a saving file name) in a two-dimensional code such as a QR code as shown in FIG. 4.

### Second Embodiment

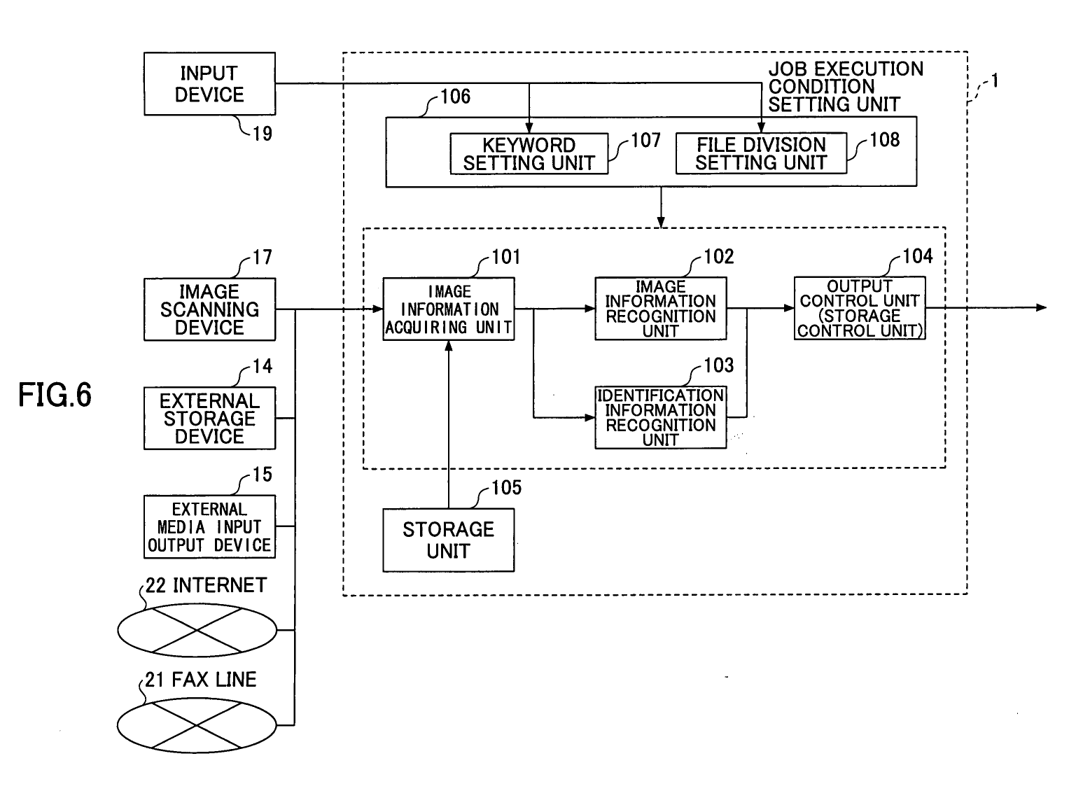

A second embodiment of the present invention is described with reference to FIGS. 6 through 11.

In the above-described first embodiment, the digital copier 1 performs a control operation of identifying and outputting (or storing) image information according to identification information included in the image information, which image information is acquired by the image scanning device 17.

In the second embodiment, a user can set the information used as the identification information by the digital copier 1. In the first embodiment, the information in a QR code included in the image information is used as the identification information. However, in the second embodiment, settings can be made so that other information such as the execution date and time of the output (or storing) operation can be used as the identification information. According to the setting contents, the digital copier 1 performs a control operation of identifying and outputting (or storing) the acquired image information. The configuration of the digital copier 1 according to the second embodiment is the same as that of the first embodiment (see FIG. 1), and therefore the description is omitted.

(Configuration of Functions)

FIG. 6 is a functional block diagram of the digital copier 1 according to the second embodiment of the present invention. The arrows connecting the blocks shown in FIG. 6 express typical flows of signals, but do not limit the functions of the blocks.

As shown in FIG. 6, the digital copier 1 includes the image information acquiring unit 101, the image information recognition unit 102, the identification information recognition unit 103, the output control unit (storage control unit) 104, the storage unit 105, a job execution condition setting unit 106, a keyword setting unit 107, and a file division setting unit 108. The difference between the block diagrams shown in FIG. 2 and in FIG. 6 is that the block diagram shown in FIG. 6 includes the job execution condition setting unit 106, the keyword setting unit 107, and the file division setting unit 108, and therefore descriptions are given only of these units.

The job execution condition setting unit 106 sets conditions for executing various jobs performed by the digital copier 1. Execution conditions for jobs are conditions for executing functions of the digital copier 1, such as the size and resolution of the image when executing a print-out job. The digital copier 1 performs various operations based on the setting contents set in the job execution condition setting unit 106. Specifically, the image information acquiring unit 101, the image information recognition unit 102, the identification information recognition unit 103, and the output control unit (storage control unit) 104 perform various operations based on the setting contents set in the job execution condition setting unit 106.

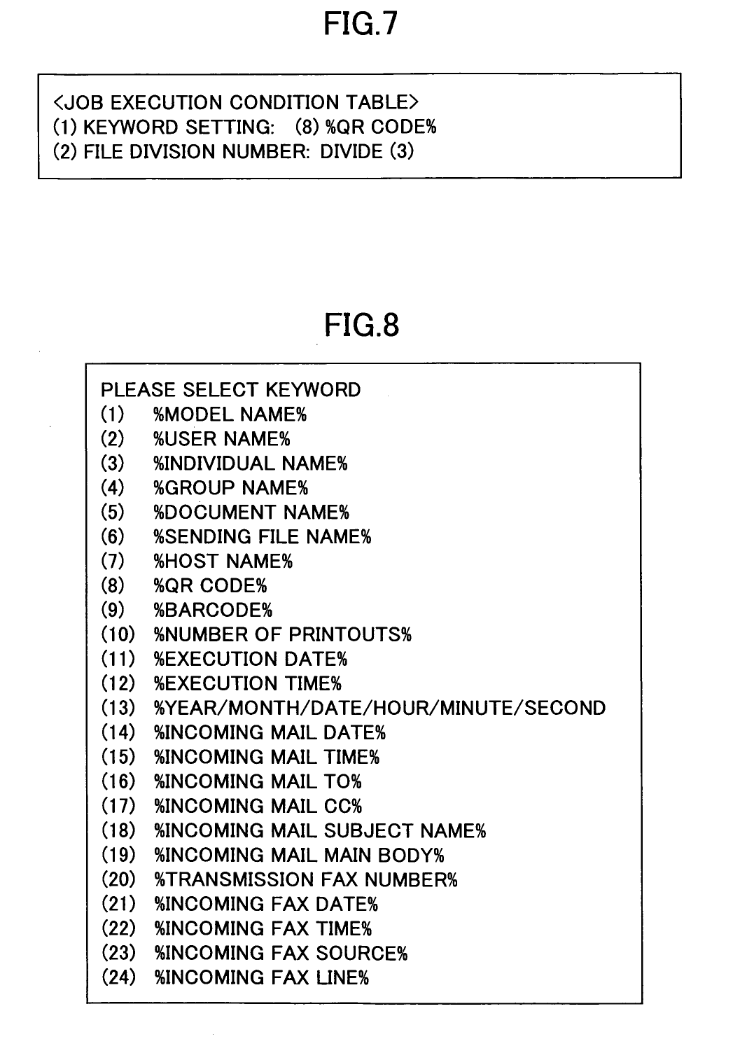

FIG. 7 illustrates an example of setting contents set in the job execution condition setting unit 106. The contents shown in FIG. 7 include setting items of “keyword setting” and “file division number”. Details about each setting item are described below in descriptions for the keyword setting unit 107 and the file division setting unit 108. The setting contents set in the job execution condition setting unit 106 are not limited thereto. Other setting items such as the size and resolution of the image at the time of outputting the image can be provided according to need.

The keyword setting unit 107 sets a keyword, which is one of the job execution conditions of the digital copier 1. In this case, a keyword is equivalent to identification information used by the digital copier 1 for identifying and outputting (or storing) the image information. In FIG. 7, “% QR code %” is associated with “keyword setting”. This indicates that all of or some of the output file names (or saving files names) used when the digital copier 1 outputs (or stores) image information are set to be converted into character strings stored in QR codes in the image information. The keyword that can be set is not limited to “% QR code %”. Examples of keywords that can be set are described with reference to FIG. 8.

FIG. 8 illustrates an example of a displayed page prompting a user to set a keyword. This keyword setting page shown in FIG. 8 is displayed on the display device 18 of the digital copier 1, and a user can select information to be used as identification information from this page. The selected information is associated with the setting item of “keyword setting”, and is held by the digital copier 1. Each item shown in FIG. 8 is described below.

“% Model name %” indicates that the file name is to be converted into the model name of the digital copier 1. “% User name %” indicates that the file name is to be converted into the user name of the individual setting. “% Individual name %” indicates that the file name is to be converted into the individual's name of the individual setting. “% Group name %” indicates that the file name is to be converted into a group name of a group where a domicile is registered. “% Document name %” indicates that the file name is to be converted into a document name specified at an accumulation tab. “% Sending file %” indicates that the file name is to be converted into a sending file name specified at a sending tab. “% Host name %” indicates that the file name is to be converted into a host name set by the system. “% QR code %” indicates that the file name is to be converted into a character string stored in a QR code in an image. “% Barcode %” indicates that the file name is to be converted into a character string stored in a barcode in an image. “% Number of printouts %” indicates that the file name is to be converted into the number of printouts to be printed out. “% Execution date %” indicates that the file name is to be converted into the date at which execution of a job starts (in a date display format of an individual setting). “% Execution time %” indicates that the file name is to be converted into the time at which execution of a job starts (in a time display format of an individual setting). “% Year/month/date/hour/minute/second %” indicates that the file name is to be converted into the date/time of executing a job in YYMMDDhhmmss format. “% Incoming mail date %” indicates that the file name is to be converted into the date at which an e-mail is received (in a date display format of an individual setting). “% Incoming mail time %” indicates that the file name is to be converted into the time at which an e-mail is received (in a time display format of an individual setting). “% Incoming mail TO %” indicates that the file name is to be converted into the addressee of a received e-mail. “% Incoming mail CC %” indicates that the file name is to be converted into the CC addressee of a received e-mail. “% Incoming mail subject name %” indicates that the file name is to be converted into the subject name of the received e-mail. “% Incoming mail main body %” indicates that the file name is to be converted into the main body of the received e-mail. “% Transmission fax number %” indicates that the file name is to be converted into a fax number to which a fax transmission has been made from the received e-mail. “% Incoming fax date %” indicates that the file name is to be converted into the date at which a fax message is received (in a date display format of an individual setting). “% Incoming fax time %” indicates that the file name is to be converted into the time at which a fax is received (in a time display format of an individual setting). “% Incoming fax source %” indicates that the file name is to be converted into the name of the source of a received fax. “% Incoming fax line %” indicates that the file name is to be converted into the name of the line with which the fax is received.

As described above, the file name can be associated with various operation flows by expressing, as a character string in %-% format, machine-unique information such as the model name, individual-unique information such as an individual's name, and job-unique information such as the date of executing a job, and then specifying the character string as an output condition.

Furthermore, with the “% QR code %” and the “% barcode %”, the QR code and the barcode input at the top page of a file input for a job can be converted into a character string. For example, when paper documents with a QR code are sent, a file name or a document name of the QR code is automatically created.

The file division setting unit 108 sets file division, which is one of the job execution conditions of the digital copier 1. File division is setting information used when the digital copier 1 outputs (or stores) plural image information items continuously scanned by the image scanning device 17. Specifically, file division is used for determining whether to output (or store) such information items as a single file or as plural divided files. In FIG. 7, “divide (3)” is associated with “file division setting”. This indicates that the image information items are to be output (or stored) as plural divided files, and the number of division units is three (i.e., three image information items are collected into each file such as a PDF file).

By setting file division in this manner, it is possible to collect image information items into PDF files in division units, and set the keyword using the function of the keyword setting unit 107. For example, by specifying “% QR code %” as the sending file name, it is possible to send PDF files each having a file name of the QR code at the top of each division unit.

With the above functional configuration, in addition to the functions described in the first embodiment, the digital copier 1 further performs control operations for identifying and outputting (or storing) the acquired image information according to the setting contents set in the job execution condition setting unit 106.

(Example of Operation)

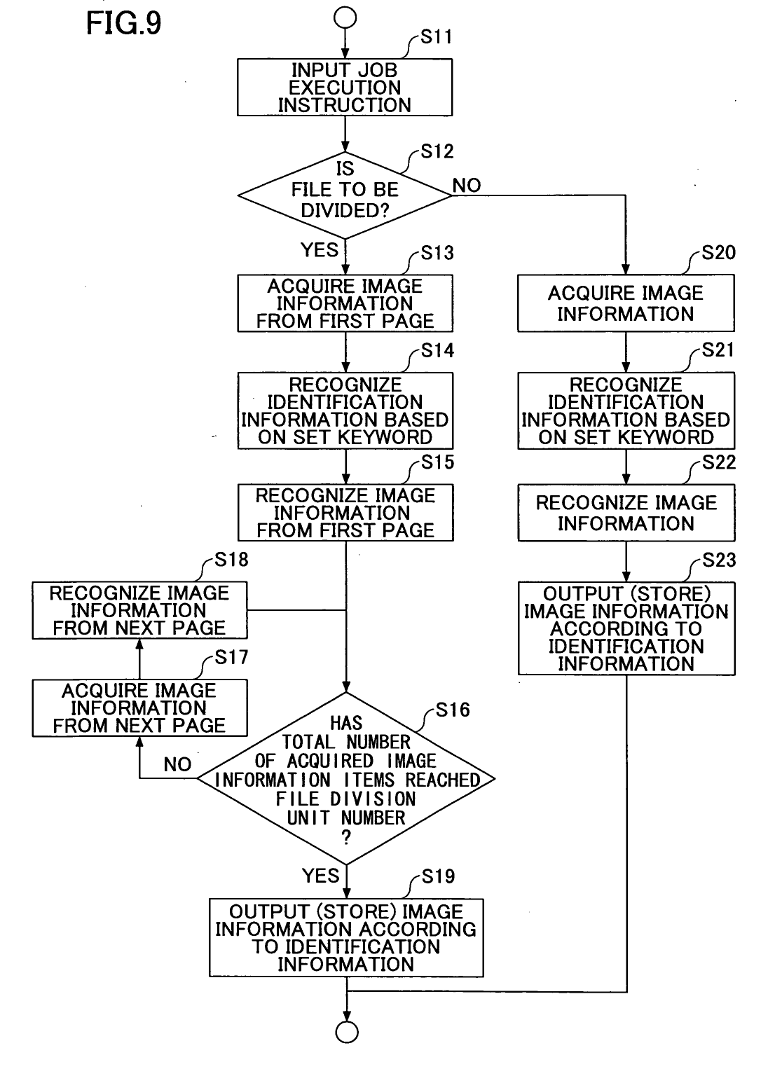

FIG. 9 is a flowchart of an operation of the digital copier 1 according to the second embodiment of the present invention. A description is given of a control operation performed by the digital copier 1, of identifying and outputting (or storing) the acquired image information according to setting contents set in the job execution condition setting unit 106, also with reference to the functional block diagram shown in FIG. 6.

First, the digital copier 1 inputs a job execution instruction (step S11). In this case, the job execution instruction is input by user input at the display device 18. Here, an instruction is input for executing a job of storing, in the storage unit 105, the image information scanned by the image scanning device 17.

Next, in step S12, the digital copier 1 determines whether there is a setting in the job execution condition setting unit 106 to perform file division (step S12). If there is a setting to perform file division (Yes in step S12), the workflow proceeds to step S13. If there is not a setting to perform file division (No in step S12), the workflow proceeds to step S20.

When the workflow proceeds to step S13, the image information acquiring unit 101 acquires image information from the first page (step S13). In this case, the image information of the first page scanned by the image scanning device 17 is acquired. The image information acquired at this step is assumed to include image data of a two-dimensional code such as a QR code shown in FIG. 4, recorded at a predetermined position.

In step S14, the identification information recognition unit 103 recognizes the identification information based on a set keyword (step S14). In this case, it is assumed that “% QR code %” is associated with “keyword setting”. As described above, the output file name (or saving file name) used when the digital copier 1 outputs (or stores) image information, is entirely or partially set in such a manner as to be converted into a character string stored in a QR code in the image information. In this case, the identification information recognition unit 103 recognizes the predetermined character string included in the QR code shown in FIG. 4 as identification information.

In step S15, the image information recognition unit 102 recognizes the image information acquired at step S13. In this case, the image information shown in FIG. 4 is recognized. Next, in step S16, the digital copier 1 determines whether the total number of image information items has reached the file division unit number (step S16). If it has (Yes in step S16), the workflow proceeds to step S19. If it has not (No in step S16), the workflow proceeds to step S17.

When the workflow proceeds to step S17, the image information acquiring unit 101 acquires image information from the next page (step S17). In this case, the image information of the next page scanned by the image scanning device 17 is acquired. The image information acquired at this step is assumed to include image data of a two-dimensional code such as a QR code shown in FIG. 4, recorded at a predetermined position. Next, in step S18, the image information recognition unit 102 recognizes the image information acquired at step S17 (step S18). In this case, the image information shown in FIG. 4 is recognized.

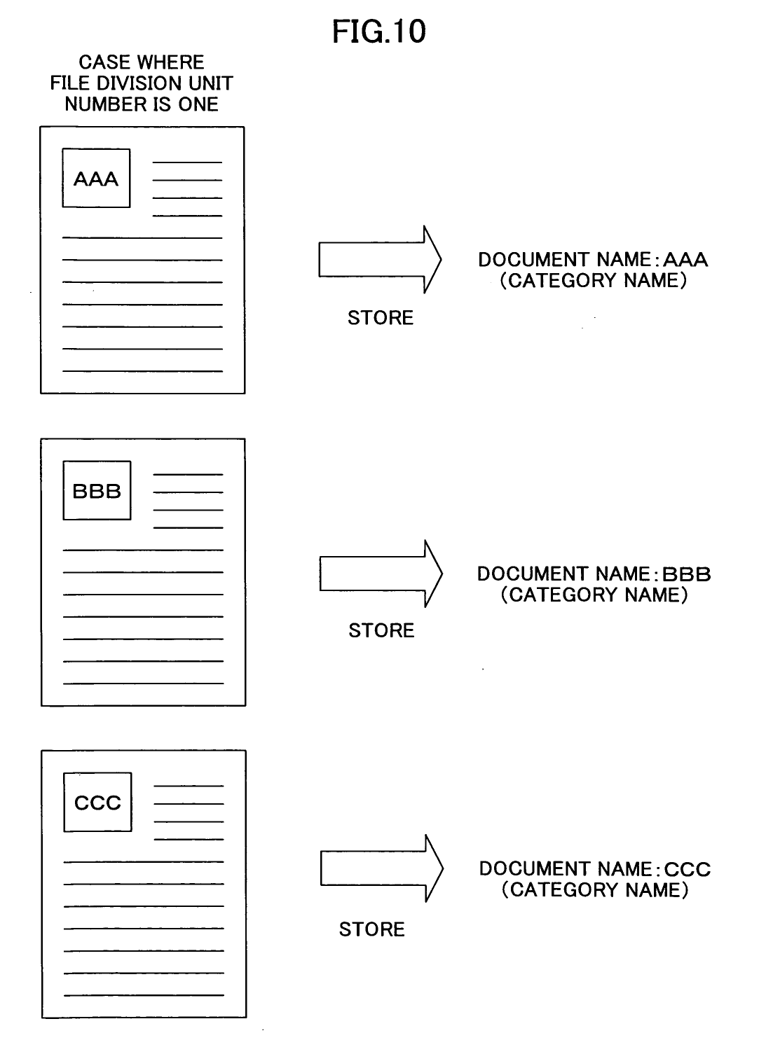

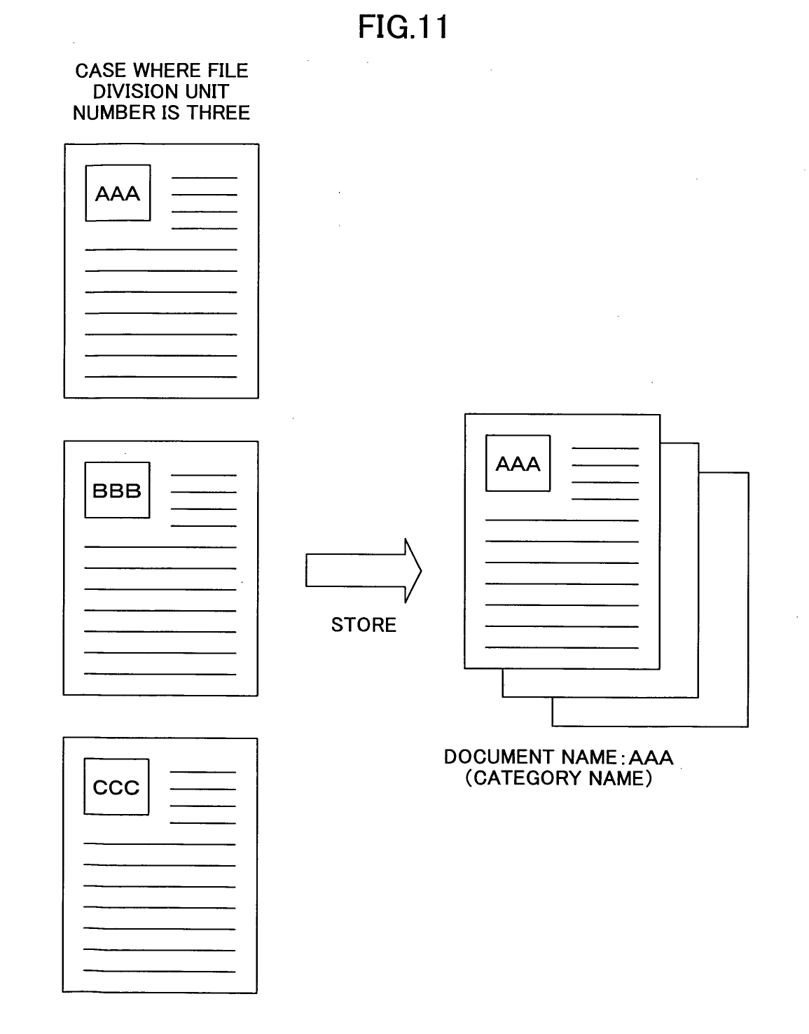

When the workflow proceeds to step S19, the output control unit 104 outputs (or stores) the image information recognized at steps S15 through S18, according to the identification information recognized at step S14 (step S19). In this case, the identification information recognized at step S14 is added to a file name (including a document name or a category name) of an electronic file such as a PDF file generated based on plural image information items continuously scanned by the image scanning device 17 with the process performed at steps S15 through S18. Then, the electronic file is stored in the storage unit 105. A more detailed description is given with reference to FIGS. 10 and 11.

FIG. 10 illustrates an operation of the digital copier 1 in a case where the file division unit number is one. When the file division unit number is one, one image information item is included in each file such as a PDF file. Furthermore, the character string stored in the QR code in each image information item is converted into a file name.

FIG. 11 illustrates an operation of the digital copier 1 in a case where the file division unit number is two or more. When the file division unit number is two or more (in the case of FIG. 11, the file division unit number is three), the scanned three image information items are included in each file such as a PDF file. The character string stored in the QR code in an image information item of the first page in each file is converted into a file name.

The process performed at steps S20 through S23 is the same as the process performed at steps S13 through S19 in the case that the file division unit number is one, and therefore the description is omitted.

According to the above process, the digital copier 1 performs control operations for identifying and outputting (or storing) acquired image information according to setting contents set in the job execution condition setting unit 106. Therefore, in addition to the advantages of the first embodiment, the user can freely set the information that is to be used as identification information by the digital copier 1.

According to one embodiment of the present invention, an image input/output apparatus includes an image information acquiring unit configured to acquire image information; an identification information recognition unit configured to recognize identification information included in the image information acquired by the image information acquiring unit; and an output control unit configured to identify and output the image information acquired by the image information acquiring unit based on the identification information recognized by the identification information recognition unit.

Additionally, the image input/output apparatus further includes a storage control unit configured to identify and store the image information acquired by the image information acquiring unit based on the identification information recognized by the identification information recognition unit.

Additionally, in the image input/output apparatus, the identification information recognition unit recognizes the identification information based on a code included in the image information acquired by the image information acquiring unit.

Additionally, the image input/output apparatus further includes an identification information setting unit configured to set the identification information, wherein the output control unit is further configured to identify and output the image information acquired by the image information acquiring unit based on the identification information set by the identification information setting unit.

Additionally, the image input/output apparatus further includes a storage control unit configured to identify and store the image information acquired by the image information acquiring unit based on the identification information recognized by the identification information recognition unit, wherein the storage control unit is further configured to identify and store the image information acquired by the image information acquiring unit based on the identification information set by the identification information setting unit.

Additionally, in the image input/output apparatus, the output control unit adds, as header information, the identification information recognized by the identification information recognition unit to the image information, and forms an image corresponding to the image information on a recording medium.

Additionally, in the image input/output apparatus, the output control unit adds the identification information to a file name of an electronic file generated based on the image information, and outputs the electronic file.

Additionally, in the image input/output apparatus, the storage control unit adds the identification information to a file name of an electronic file generated based on the image information, and stores the electronic file.

Additionally, in the image input/output apparatus, the image information acquiring unit acquires the image information by scanning an image recorded on a recording medium.

Additionally, in the image input/output apparatus, the image information acquiring unit acquires the image information from an electronic file including the image information received from an external device connected via a network.

Additionally, in the image input/output apparatus, the image information acquiring unit acquires the image information from information stored in a storage device provided inside or outside the image input/output apparatus.

According to one embodiment of the present invention, an image input/output method is performed by an image input/output apparatus for inputting/outputting image information, the image input/output method including an image information acquiring step of acquiring image information; an identification information recognition step of recognizing identification information included in the image information acquired at the image information acquiring step; and an output control step of identifying and outputting the image information acquired at the image information acquiring step based on the identification information recognized at the identification information recognition step.

The present invention is not limited to the specifically disclosed embodiment, and variations and modifications may be made without departing from the scope of the present invention.

The present application is based on Japanese Priority Patent Application No. 2007-169789, filed on Jun. 27, 2007, the entire contents of which are hereby incorporated herein by reference.

What is claimed is:

1. An image input/output apparatus comprising:
an image information acquiring unit configured to acquire image information;
an identification information recognition unit configured to recognize identification information included in the image information acquired by the image information acquiring unit; and
an output control unit configured to identify and output the image information acquired by the image information acquiring unit based on the identification information recognized by the identification information recognition unit.

2. The image input/output apparatus according to claim 1, further comprising:
a storage control unit configured to identify and store the image information acquired by the image information acquiring unit based on the identification information recognized by the identification information recognition unit.

3. The image input/output apparatus according to claim 1, wherein:
the identification information recognition unit recognizes the identification information based on a code included in the image information acquired by the image information acquiring unit.

4. The image input/output apparatus according to claim 1, further comprising:
an identification information setting unit configured to set the identification information, wherein:
the output control unit is further configured to identify and output the image information acquired by the image information acquiring unit based on the identification information set by the identification information setting unit.

5. The image input/output apparatus according to claim 4, further comprising:
a storage control unit configured to identify and store the image information acquired by the image information acquiring unit based on the identification information recognized by the identification information recognition unit, wherein:
the storage control unit is further configured to identify and store the image information acquired by the image information acquiring unit based on the identification information set by the identification information setting unit.

6. The image input/output apparatus according to claim 1, wherein:
the output control unit adds, as header information, the identification information recognized by the identification information recognition unit to the image information, and forms an image corresponding to the image information on a recording medium.

7. The image input/output apparatus according to claim 1, wherein:
the output control unit adds the identification information to a file name of an electronic file generated based on the image information, and outputs the electronic file.

8. The image input/output apparatus according to claim 2, wherein:
the storage control unit adds the identification information to a file name of an electronic file generated based on the image information, and stores the electronic file.

9. The image input/output apparatus according to claim 1, wherein:
the image information acquiring unit acquires the image information by scanning an image recorded on a recording medium.

10. The image input/output apparatus according to claim 1, wherein:
the image information acquiring unit acquires the image information from an electronic file comprising the image information received from an external device connected via a network.

11. The image input/output apparatus according to claim 1, wherein:
the image information acquiring unit acquires the image information from information stored in a storage device provided inside or outside the image input/output apparatus.

12. An image input/output method performed by an image input/output apparatus for inputting/outputting image information, the image input/output method comprising:
an image information acquiring step of acquiring image information;
an identification information recognition step of recognizing identification information included in the image information acquired at the image information acquiring step; and
an output control step of identifying and outputting the image information acquired at the image information acquiring step based on the identification information recognized at the identification information recognition step.
